(19) United States
(12) Patent Application Publication
(10) Pub. No.: US 2006/0007386 A1
(43) Pub. Date: Jan. 12, 2006

(54) Flat top tunable filter with integrated detector

(75) Inventors: Shanti A. Cavanaugh, Santa Rosa, CA (US); Gary M. Zalewski, Oakland, CA (US)

Correspondence Address: MORRISON & FOERSTER LLP, 1650 TYSONS BOULEVARD, SUITE 300, MCLEAN, VA, 22102, US

(73) Assignee: Extellus USA

(21) Appl. No.: 10/607,855

(22) Filed: Jun. 27, 2003

Related U.S. Application Data
(63) Continuation-in-part of application No. 10/453,455, filed on Jun. 2, 2003, now abandoned.
Application No. 10/453,455 is a continuation-in-part of application No. 10/391,510, filed on Mar. 17, 2003.
(63) Continuation-in-part of application No. 10/394,400, filed on Mar. 19, 2003, now Pat. No. 6,778,251.
Application No. 10/394,400 is a continuation-in-part of application No. 10/371,235, filed on Feb. 21, 2003.

(51) Int. Cl. G02F 1/13

(52) U.S. Cl. 349/202

(57) ABSTRACT

A free space tunable filter produces a passband output as a result of sequential processing by an array of narrowband tunable filters (NBTFs) each tuned to a slightly different frequency. The present invention is comprised of one or more stages having multiple interleaved sectors and comprising an array of NBTFs having a masked outer surface reflective coating. Stages cascading is used to increase the device figure of merit and single stages are partitioned into multiple sectors that process a specific interleaved region of the bandwidth. Final stage output group passband signals are combined in a multiplexer and tapped with a partially transparent photodetector.

### CROSS-REFERENCE TO RELATED APPLICATIONS

This application is a continuation-in-part of the commonly assigned U.S. patent application titled “NARROW BAND TUNABLE FILTER WITH INTEGRATED DETECTOR”, filed on Jun. 2, 2003, Ser. No. 10/453,455 which is hereby incorporated herein by reference; and commonly assigned U.S. patent application titled, “MULTI-PIXEL LIQUID CRYSTAL CELL ARRAY”, filed on Mar. 17, 2003 and having Ser. No. 10/391,510 which is hereby incorporated herein by reference; and commonly assigned U.S. patent application titled “LIQUID CRYSTAL OPTICAL PROCESSING SYSTEMS”, filed on Mar. 19, 2003 and having Ser. No. 10/394,400 which is hereby incorporated herein by reference; and commonly assigned U.S. patent application titled “LIQUID CRYSTAL CELL PLATFORM”, filed on Feb. 21, 2003 and having Ser. No. 10/371,235 which is hereby incorporated herein by reference.

### FIELD OF INVENTION

This invention generally relates to electrically tunable optical filters. More specifically, this invention relates to a free space liquid crystal tunable filter offering a passband output waveform having a flat top and steep skirts.

### BACKGROUND OF THE INVENTION

Since the advent of fiber optics, the fiber optical communication infrastructures have become more diverse and sophisticated. The fiber optic applications range from low speed, local area networks to high speed, long distance telecommunication systems. In recent years, the demands for greater bandwidth and lower network costs have resulted in increasing use of dynamic, tunable components.

Tunable optical filters are of particular importance because they can be configured to perform a variety of critical network functions; including channel selection and optical power monitoring.

Prior art techniques to construct tunable optical filters include the acousto-optic tunable filter which operates by using an acoustic wave simulated by a radio-frequency power supply and transducer to induce densification and rarefaction in an optical waveguide material. In practice, acoustic-optic tunable filters usually work by changing the polarization of light at a wavelength that is matched to the acoustically induced grating which results in separation of tuned wavelength from the other wavelength components. Tuning is accomplished by changing the frequency of the applied acoustic wave. Acoustic-optic devices provide rapid tuning in the microsecond range and complete blanking of the filter, however they are not polarization independent devices and suffer from poor adjacent channel rejection and high insertion loss.

Optical nanostructures have been the object of scientific investigation for several years but advances in material science and imprint lithography have only recently resulted in their cost effective manufacturing and availability. An optical nanostructure is derived with feature sizes below the wavelength of light, so they offer uniform behavior over a broad wavelength, wide acceptance angles and unique optical properties by function of varying dimensions of the underlying grating features. Most recently, optical nanostructures have been designed to function as a resonant waveguide, which, when coupled to an active layer capable of changing its index of refraction, is a foundation for tomorrows tunable waveguide filter.

Liquid crystals are known to change their index of refraction with the application of voltage and can be dynamically controlled and configured to enable a range of optical switching and signal conditioning applications. Formed with opposing plates of sealed substrates, liquid crystal cells are considered a prospect technology and integration target capable of supplying the active layer to a nanostructure integrated therewith. Wang et. Al has recently demonstrated an experimental electrically tunable filter based on a waveguide resonant sub-wavelength nanostructure-grating filter incorporating a tuning mechanism in a thin liquid crystal. The device did not produce a flat top output nor did it address temperature stability issues associated with robust control of liquid crystal devices.

The advantages of liquid crystal based tunable filter over existing technologies include durability due to the absence of mechanical moving parts, no stretchable medium required as in prior art tunable filters and derivatives, no loss of optical performance in the event of mechanical failure, no fatigue resulting from mechanical failure occurring over time and the ability to provide tunable filter arrays with multiple tuning pixels.

Given the assertion that tunable devices can be achieved at low cost by way of integrating active liquid crystal with passive integrated nanostructured gratings, the present invention addresses the need for a free space, low cost polarization independent tunable filter that offers a flat top output waveform having steep skirts and capable of operating in a reliable manner across a range of temperature and atmospheres.

### FEATURES OF THE INVENTION

The present invention contains several features and embodiments that may be configured independently or in combination with other features of the present invention, depending on the application and operating configurations. The delineation of such features is not meant to limit the scope of the invention but merely to outline certain specific features as they relate to the present invention.

It is a feature of the present invention to provide a free space flat top tunable filter.

It is a feature of the present invention to provide a tunable filter that may be used in a variety of applications, including but not limited to those in the field of optical telecommunications.

It is a feature of the present invention to provide a tunable flat top filter that operates without moving parts.

It is a feature of the present invention to provide a tunable filter that may be configured with multiple stages to increase the figure of merit performance characteristic, skirt steepness of the output passband waveshape.

It is a feature of the present invention to provide a tunable filter that utilizes a plurality of pixels each tuned to a slightly different center wavelength frequency to maximize the optical flatness of the output waveform.

It is a feature of the present invention to provide a polarization independent flat top tunable filter.

It is a feature of the present invention to provide a free space tunable filter that may be configured with an integrated photodetector.

It is a feature of the present invention to provide a tunable filter that may be constructed from materials integrated with subwavelength optical nanostructured elements.

It is a feature of the present invention to define a simple and novel control method for tuning a flat top tunable filter having an array of NBTF by way of a common electrode.

It is a feature of the present invention to provide a flat top liquid crystal tunable filter that may be constructed from materials substantially impervious to moisture.

It is a feature of the present invention to provide liquid crystal flat top tunable filter that may contain a heater and temperature sensor integrated therein as single physical element and to provide for accurate and uniform control of heating and temperature sensing across all NBTF pixels in the device.

It is a feature of the present invention to provide a novel method of operating a flat top liquid crystal tunable filter across a range of temperature without the need for lookup tables otherwise used to compensate for real time temperature changes.

It is a feature of the present invention to provide a flat top liquid crystal tunable filter that passes the strict telecommunications guidelines as outlined in Telcordia GR1221 without the need for hermetic housing.

It is a feature of the present invention to provide a flat top liquid crystal tunable filter that is not prone to permanent and irreversible warpage when exposed to various thermal and humidity atmospheres.

### SUMMARY OF THE INVENTION

The disadvantages associated with the prior art may be overcome by a free space tunable filter that produces a passband output as a result of sequential processing by an array of narrowband tunable filters (NBTFs) each tuned to a slightly different frequency. The present invention is comprised of one or more stages, each having parallel reflective sidewall surfaces positioned in opposition to each other sandwiching an array of NBTFs. An input signal cascades through a stage bouncing off the sidewalls and the NBTFs which reflect a passband and transmit a transmission band, the compliment of the passband. Maximum optical flatness and minimum insertion loss are achieved by interleaving the NBTF center wavelengths to minimize the amount of overlap between any two sequential filters. Stages are cascaded to increase the device figure of merit and single stages are partitioned into multiple sectors that process a specific interleaved region of the bandwidth. Sector output includes group passband and group transmission band signals, where the group transmission signal couples to the input of the next sequential sector within that stage while the group passband signal couples to the input of a next cascaded stage. At the output of the final stage, all group passband signals are combined in a multiplexer and tapped with a partially transparent photodetector.

### BRIEF DESCRIPTION OF THE FIGURES

FIG. 1A shows a functional block diagram of the present invention.

FIG. 1B shows a block diagram of the present invention configured with a single stage.

FIG. 1C shows a block diagram 1^{st} filter stage with N sectors.

FIG. 1D-1E show a detailed two sector 1^{st} filter stage and the optical path of the single input and double outputs.

FIG. 1F shows the spectrum of two group passband signals output from a two sector filter along with the combined waveform.

FIG. 2A shows an example spectral output of a double stage filter having 10 sectors.

FIG. 2B shows an example spectral output of a triple stage filter having 10 sectors.

FIG. 2C shows an example spectral output of a quadruple stage filter having 10 sectors.

FIG. 3A shows a detailed two sector Xth stage filter configured with a metal gasket, spacer element and thermal heater/sensor device.

FIG. 3B shows an example filter with integrated mux and tap detector.

FIG. 4 shows an example cross section detail of a stage and its components.

FIG. 5 shows one process flow for fabricating the tunable filter of the present invention.

FIGS. 6A and 6B show four pixel indium tin oxide (ITO) electrode forming masks which may be adapted for use in the present invention.

FIGS. 7A and 7B show example integrated active thermal element forming masks which may be adapted for use in the present invention.

FIGS. 8A and 8B show example spacer element forming masks which may be adapted for use in the present invention

FIGS. 9A and 9B show example masks for defining a metal gasket element layer that may be adapted for use in the present invention.

FIG. 10A shows a top view integrated perspective of a simplified liquid crystal structure to exemplify basic relationships between various packaging layers which may be configured into a NBTF array of the present invention.

FIG. 10B is an isometric view showing an example liquid crystal structure at the termination of the fabrication process only to demonstrate the relationship between

FIG. 11 shows the liquid crystal thermal calibration and feedback loop method flows.

FIG. 12 shows a block system diagram for the electronic control and thermal management system of the present invention.

### DETAILED DESCRIPTION

Throughout this application, like reference numbers as used to refer to like elements. For instance, the two substrates used to form the liquid crystal cell of the present invention are referred to throughout this applications as 110A and 110B. Those supporting elements and features of the invention that are distributed on each substrate and later combined may be referred to under their index reference for a particular substrate ′A, ′B or for simplicity sake, under the shared reference ′. Narroband tunable filter pixels used in the present invention are hereafter termed “NBTF pixels” and are individually addressed by reference 100^{stage, sector, sequence} where sequence is the sequential order reference for any pixel. N is used throughout to designate sector number. X is used throughout to designate an arbitrary stage in the system. Reference 15^{stage,sector} is used throughout to index a group passband output in the system. Reference 85^{x} is used throughout to index an arbitrary stage in the system.

U.S. patent application titled “Narrow Band Tunable Filter with Integrated Photodetector”, filed Jun. 2, 2003, having Ser. No. 10/453,455 and incorporated herein by reference, enables the use of liquid crystal to actively tune the center frequency of a polarization independent narrow band tunable filter (NBTF) by the application of voltage to the liquid crystal cell. In assimilation therewith and in consideration to U.S. patent application titled “Multi-Pixel Liquid Crystal Cell Array”, filed Mar. 17, 2003, having Ser. No. 10/391,510 and also incorporated herein by reference, it is hereby asserted that one skilled in the art is now provided with a complete understanding of the present invention:

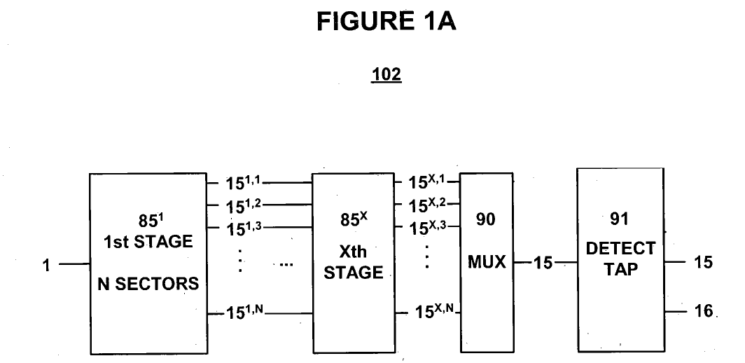

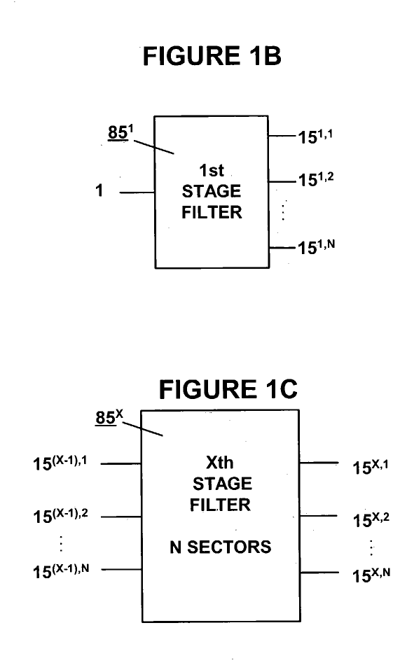

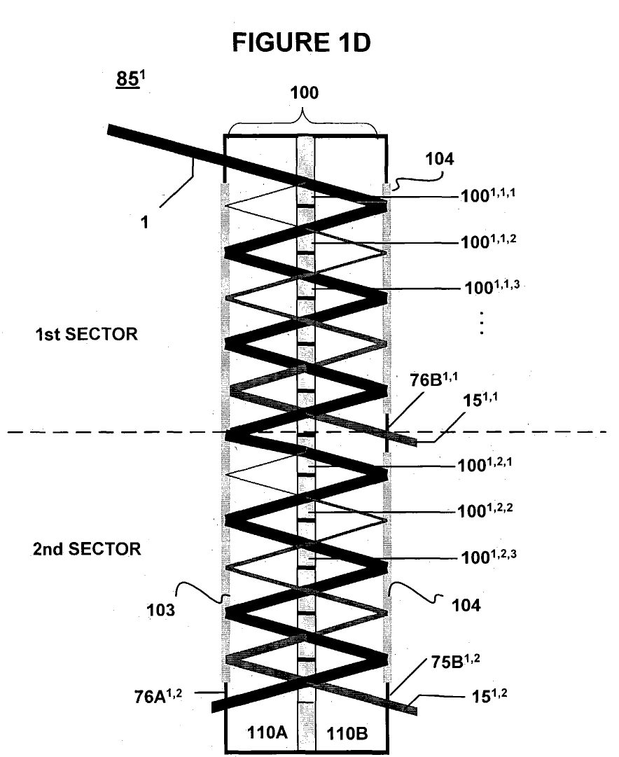

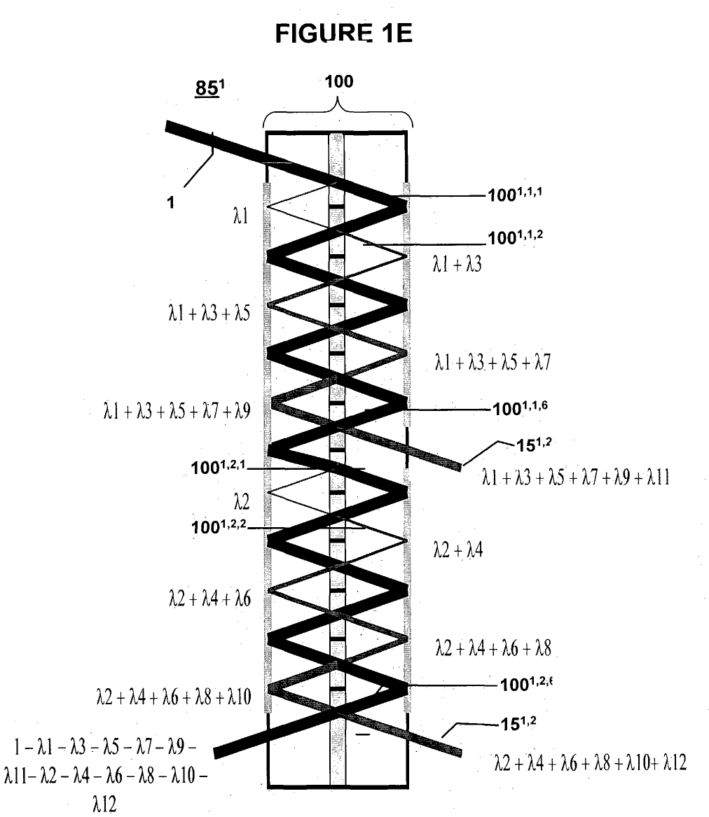

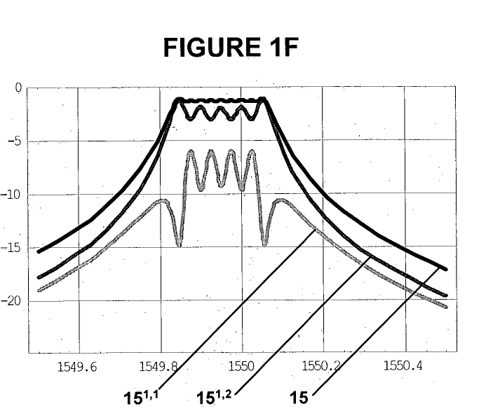

The tunable filter of the present invention is presented in FIG. 1A, wherein an input optical beam 1 enters a first stage 85¹ filter containing N interleaved sectors. Each sector filters a portion of the input signal across a wavelength region and produces a group passband output signal 15^{1,sector} associated with the sector. A total of N group passband output signals are produced by the first stage, and each couple to the input of a sector in a successor stage. All stages are configured substantially identical to each other except the first stage, which has a single input, as shown in FIG. 1B. Additional stages re-filter and multiply the effects of the filter function, resulting in increasing the figure of merit of the output waveform. As shown in FIG. 1C, any arbitrary stage of the present invention, X, is configured to couple the group passband output from each sector of the previous stage, in so producing re-filtered group passband outputs which may couple to a successor stage or be combined for output from the device.

All group passband outputs from the final stage are combined in multiplexer 90 and may be tapped with a partially transparent optical detector 91.

FIG. 1D shows a detailed example a first stage of the present invention which is comprised of an NBTF pixel array 100 having parallel reflected surfaces 102 and 103 on the outer substrates 110A and 110B. An input signal 1 having a diameter preferably less than 400 microns passes through a patterned gap in a first reflective sidewall at a predetermined angle of 10 degrees, striking the first pixel 100^{1,1,1} in the stage which splits the signal into a reflected passband and complimentary transmission band. Signal carrying the reflected passband bounces off the first pixel into the surface 102 and back toward the center of the next pixel 100^{1,1,2} for processing thereby. Meanwhile, its complimentary signal, the portion of the input signal 1 that passed through pixel 100^{1,1,1} continues until it reaches the opposing reflective surface 103 at which point it bounces off the second reflective sidewall back toward the center of the next pixel 100^{1,1,2} for processing thereby.

Since the NBTF pixels in the system will process light from both reflective surfaces 102 and 103 and therefore from both sides of a pixel, it is critical that any alternative NBTF pixels which may be configured into a system are capable of bi-directional operation.

FIG. 1D shows how the input signal 1 propagates through a stage. Each pass through a pixel results in the accumulation of additional transmission and passband spectra. The transmission and passband spectra are accumulated into two distinct optical paths, and at the end of a sector, the accumulated group passband 15^{1,1} is output through a patterned hole 76B^{1,1} in the reflective surface 103 applied to the outer surface of substrate 110B. Meanwhile, the group transmission band from the first sector continues to traverse the stage to the next pixel, which is associated with the second sector in the system. The identical operation as described above is repeated in the second sector to accumulate group passband 15^{1,2} for output through masked hole 76B^{1,2} The accumulated group transmission band is discarded since it falls outside of the passband of the filter.

An important element of the present invention is sector interleaving, which is now described with respect to FIG. 1E, which shows the optical function of an interleaved stage having NBTF center wavelengths tuned in a specific order across the desired passband, which, in the example shown is designated by the period starting with lambda 1 and ending with lambda 12. A two sector stage has a 1:2 order interleave, which means that any two sequential pixels in a sector will be tuned with center wavelengths that are non-adjacent in the center wavelength sequence. This is demonstrated in FIG. 1E which shows that the first pixel 100^{1,1,1} is tuned to lambda 1, the next pixel 100^{1,1,2} is tuned to lambda 3, the third pixel 100^{1,2,3} is tuned to lambda 5 and so forth to derive an accumulated group passband for sector 1 equal to lambda 1+lambda 3+lambda 5+lambda 7+lambda 9+lambda 11. The compliment of the group passband or transmission band is then reprocessed in the second sector which has pixels tuned to complimentary or, in the case of a 1:2 interleave, even numbered lambdas.

FIG. 1F shows an example output of a stage having two sectors with 5 pixels on the first sector and four pixels on the second sector using a NBTF array where each pixel has a bandwidth of 0.05 nm and center wavelength spacing of 0.02 nm. As shown in FIG. 1F, the group passband output from the first sector 15^{1,1} is interleaved with the output from the group passband from the second sector 15^{1,2}. The combination or muxing of group passband outputs from this stage deliver an output waveform 15.

It should be understood that increasing the number of pixels configured in a stage and the number of sectors of the flat top tunable filter will result in decreased ripple on the flat portion of the output waveform 15. It should also be understood that stages may be cascaded to increase the figure of merit performance of the filter, as additional stages multiply the optical function of any one stage to produce an output with sharper skirts but higher insertion loss.

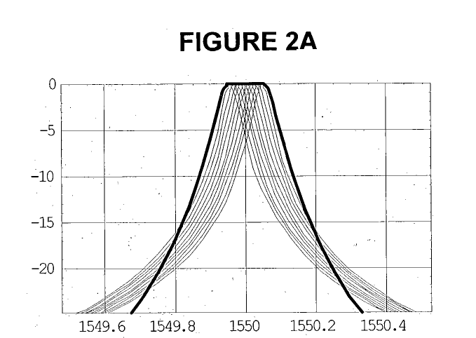

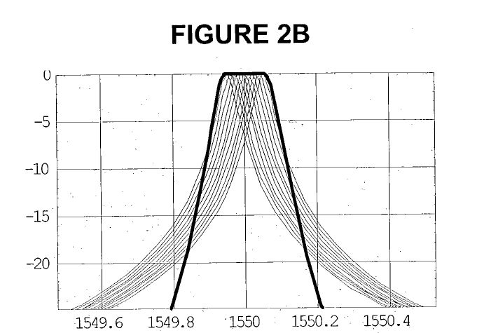

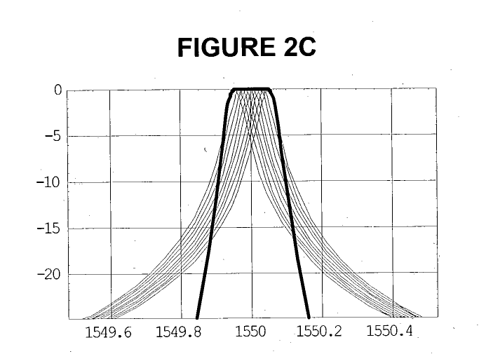

FIG. 2A demonstrates the dynamics of these principles by way of an output waveform from a second stage tunable filter configured with 10 sectors having one pixel per sector in a device using a NBTF with bandwidth of 0.05 nm and center wavelength resolution of 0.01 nm. As seen in FIGS. 2B-2C, the results of an additional third and fourth stage increase the figure of merit substantially.

As shown in FIG. 2C, a four stage flat top tunable filter of the present invention offers a figure of merit of around 0.5, which is generally higher than any existing fixed, thin film flat top filter (NOTE: “figure of merit” is a performance metric known in the art and defined by the ratio of bandwidth at −0.3 db to the bandwidth of the device output passband as measured at −25 db. A figure of merit of 1 is a perfect filter having completely vertical skirts).

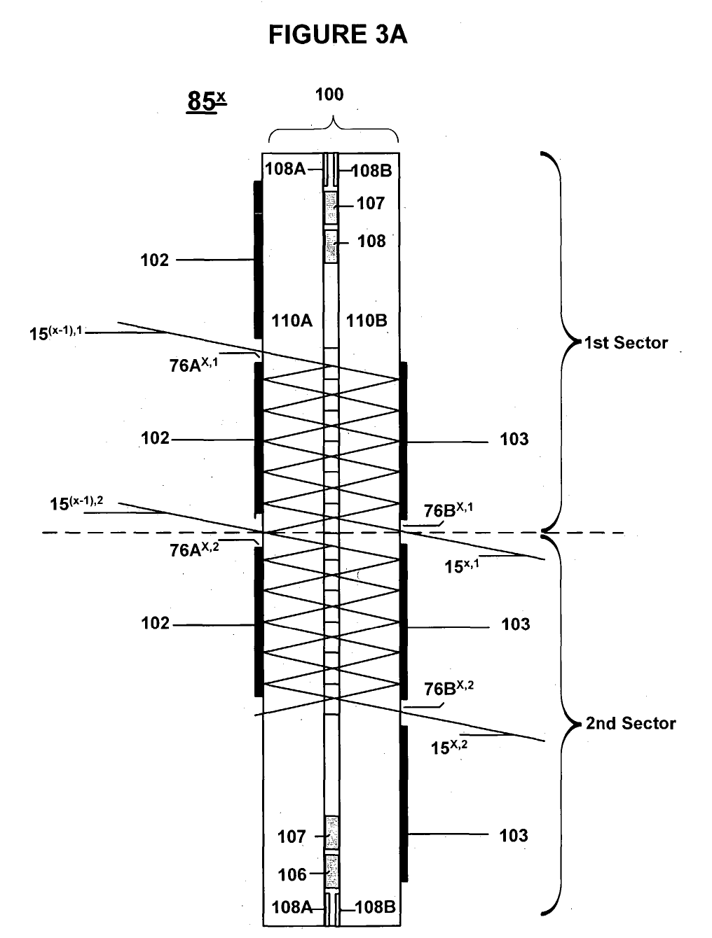

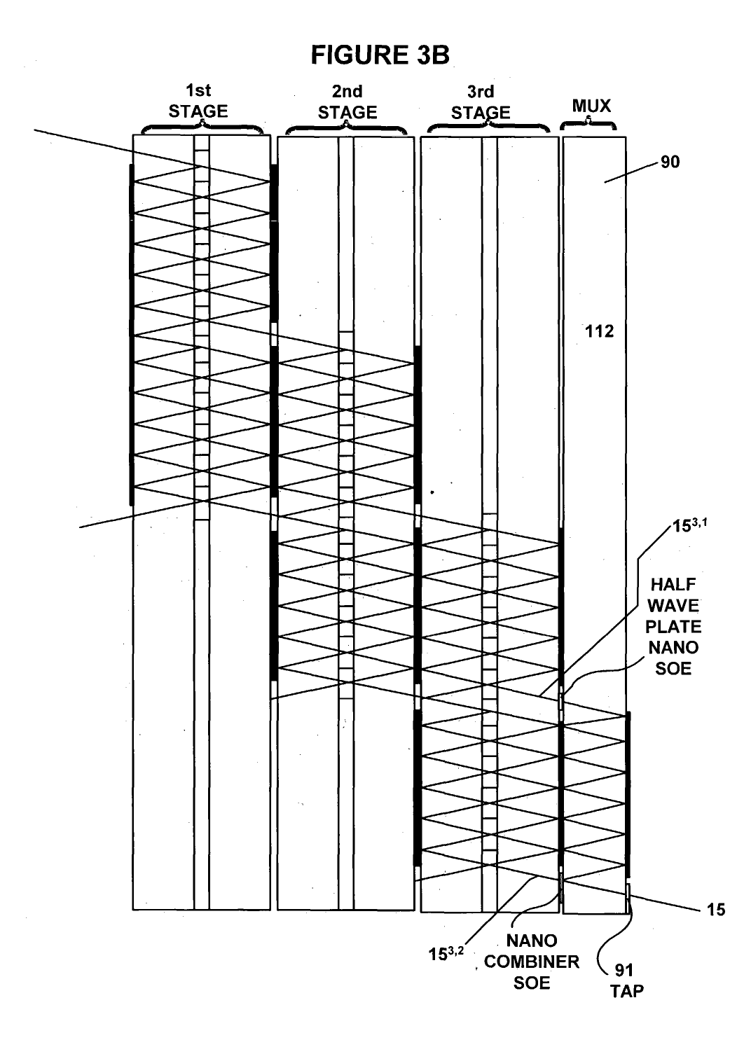

FIG. 3A shows an arbitrary stage configured with two sectors having six pixels per sector. Of particular interest is the multiple inputs 15^{(x-1),1} and 15^{(x-1),2} which couple from the previous stage (X−1) to the current stage, X. As shown in FIG. 3A, holes 76A^{x,1} and 76A^{x,2} are patterned into the reflective surface 102 to enable the group passband outputs from sectors in the previous stage to couple into the appropriate sectors in the current stage.

FIG. 3B details an example of how integrated stages may couple together with respect to the optical path and the masked holes on the input and output side of each sector and stage. FIG. 3B also highlights a novel integrated MUX 90 which may be coupled to the final stage outputs to recombine the outputs into a single beam. MUX 90 is preferably comprised of a half wave plate nanostructured optical element capable of providing a fixed rotation to the first sector output 15^{3,1} to allow the first sector output to be orthogonal to the second sector output and propagate several bounces through glass substrate 112, which is reflective on both sides and defined by a thickness that allows the final bounce to strike a combiner optical element at a specified offset height equal to the offset height of the second sector group passband 15^{3,2} for which the combiner will mix the outputs in the formation of the flat top tunable filter output 15 which is tapped by an integrated photodetector tap 91. The combiner preferably consists of a nanostructured grating polarization beam splitter (PBS) which transmits one polarization and reflects the orthogonal polarization.

The photodetector tap 91 may be formed by way of standard iterative processes consisting of multiple deposition stages to apply the appropriate PIN diodes based on silicon and germanium alloys for a partially transparent photodetector. Conductors for connecting to and contacting the photodetectors may be made from various metals or transparent oxides, including gold, zinc oxide, tin oxide and indium tin oxide.

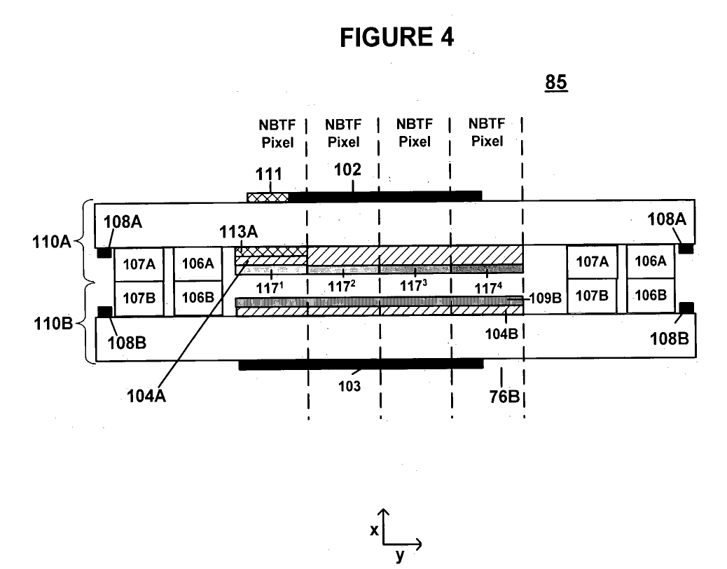

FIG. 4 shows a four pixel example of a first stage 85 having a first glass substrate 110A in opposition to a second glass substrate 110B. The first pixel has, in the aperture, an essential inner surface layer stack comprising a polarization beam splitter 113, a conductive electrode layer 104 and waveguide resonant grating filter 117¹. All other pixels have a conductive electrode layer 104 and waveguide resonant grating filter 117^{2 . . . last pixel}. As shown in FIG. 1D, on the outer surface of the first substrate is a patterned quarter wave rotating optical element 111 and the reflective surface 102. The portion of the incoming beam which is polarized orthogonal to the PBS is reflected towards a quarter wave optical reflector. The quarter wave optical reflector rotates an input beam by one quarter wave as it enters and by one quarter wave as it exists the optical element 111 such that the total beam rotation is one half wave after reflection. As so, two beams pass through a NBTF pixel in any one direction with the same polarization. On the inner surface of the first substrate is a non essential metal gasket seal layer 106A and thin film spacer layer 107A. In this embodiment, the second substrate 110B has a conductive electrode layer 104B and a liquid crystal alignment layer 109B, and on the outer surface is a patterned reflective surface 103. As shown in FIG. 1, outside of the aperture on the inside surface of the second substrate is an optional metal gasket seal layer 106B and spacer layer 107B. Liquid crystal molecules disposed in the aperture between the substrates 110A and 110B may be held in place by the metal gasket seal 106.

Still with respect to FIG. 4, each NBTF pixel has an associated grating filters 117¹ . . . 117⁴ consisting of gratings on planar waveguide that are nominally transparent to an incident plane wave away from the resonance condition but reflect the externally incident plane wave at the resonance condition. All components of the gratings filters, including but not limited to the waveguide cladding, core, grating, etc, may each be deposited in a single step using a master mask that established the appropriate grating parameters for each NBTF pixel. The gratings will be configured based on the stage, number of pixels and sectors within each stage.

The NBTF grating filters 117 preferably comprise a grating and a waveguide. The grating may be sourced from NanoOpto Inc. of Somerset N.J. or formed by way of nano-imprint lithography or similar lithography processes as generally understood in the art or herein described. It is preferred that the period of the grating is 450-480 nanometers and have a depth of 220 nanometers. The waveguide may comprise a silicon nitride core approximately 480 nanometers thick and a silicon dioxide cladding approximately 1.5 microns thick. The index of refraction of the core is preferred to be 2.95 but may range 2.3 to 3.05.

The parameters of each NBTF are selected to predispose NBTF pixels with different resonant center wavelength frequencies according to the interleave scheme in the stage. This approach simplifies control electronics, enabling a voltage to a common electrode layer impute a frequency shift across all pixels in the system and eliminates the need to individually control each NBTF with multi-channel DACs. Individual control of each NBTF is another feasible approach within the scope of the present invention and described later in the control section.

Based on the parameters above, the tuning range of the flat top liquid crystal tunable filter pixel of the present invention may exceed 100 nanometers. Tuning is achieved by the application of a voltage across the conductive electrode layers 104A and 104B of each stage, imputing a change in index of refraction and resonant wavelength of the NBTFs.

Fabrication

With respect to all embodiments, it is generally preferable that substrate 110 be comprised of glass but other substrate materials, including Garnet, silicon, polymers, etc., may be suitable depending on special pixel constructs and tailored tunable applications.

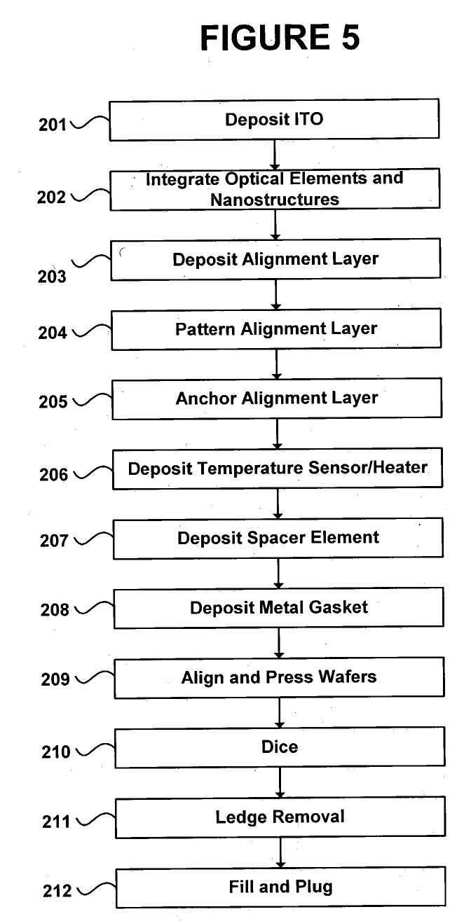

FIG. 5 shows one example fabrication process to create the NBTF cell array 100. Various optional steps may be omitted depending on the embodiment of configured features.

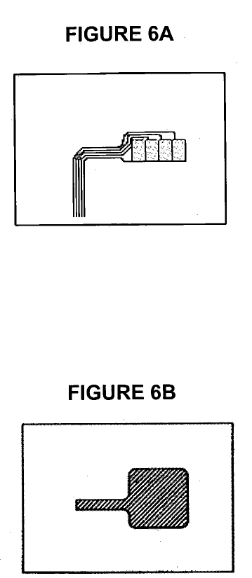

Step one involves adding the appropriate ITO (or other transparent conductive material) patterns to the first and second glass substrates to form the liquid crystal electrodes. With respect to process flow 201 of FIG. 5, a standard PECVD process may be used to apply thin film of ITO approximately 100 nanometers thick. FIGS. 6A and 6B show example ITO masks that may be used to pattern substrates 110A and 110B, respectively.

With respect to FIG. 5, step two involves integrating the optical elements and layer stacks into the first and second substrates. The optical elements may be formed by way of nano-imprint lithography techniques or similar methods known in the field and including those based on impressing a reference mask into photo resist to create surface relief patterns on the substrate where the surface relief photo resist pattern is etched to form grating features in the nanometer range. Preferably, the optical elements are deposited nanostructured gratings such as those available from NanoOpto Corporation of New Jersey who specifically offer the required optical elements, including the quarter wave reflector 111 and the waveguide resonant grating 117.

With respect to process step 202, the substrates are etched using nanoimprint lithography or similar methods known in the field and including those based on impressing a reference mask into photo resist to create surface relief patterns on the substrate where the surface relief photo resist pattern is etched to form grating features in the nanometer range. A uniform optical element mask may be used to pattern a global optical function across multiple pixels or the mask may be designed to provide local optical functions at referential pixel locations. The waveplate and mirror optical elements are preferably integrated the substrate but may also be supplied as a discreet chip and bonded to the target substrate by way of epoxy or other methods described herein or otherwise generally known.

Step three involves adding a polyimide alignment layer to the second substrate 101B. With respect to process flow 203 of FIG. 5, standard spin coating stepped processes may be used at room temperature to create a layer of polyimide approximately 7000 angstroms thick on the second substrate.

Step four involves patterning the polyimide layer. With respect to process 204, photo resist may first be applied to substrate 101B and masked using traditional photolithography techniques or laser etching. Wet or dry etching performed thereafter may result in a pattern of polyimide.

Step five involves anchoring the liquid crystal alignment layer. With respect to process step 205, one traditional method is to rub the polyimide to form the alignment layers. In the electronically conductive birefringence (ECB) configuration of the present invention, the rubbing direction of the second substrate may be parallel to the equivalent homeotropic alignment provided by the grating waveguide filters 117. A first alternate method of forming the second substrate alignment layer is to an imprint lithography technique where a reference mask is pressed onto a deposited photo resist layer to create surface relief patterns in the photo resist which is subsequently etched to form high precision alignment grooves with nanoscale tolerance.

Steps three, four and five as mentioned above may be replaced by a second alternative method of the anchoring step and involves the use of a photo sensitive anchoring medium, such as Staralign by Vantio of Switzerland. The photosensitive anchoring medium may be spin applied to the substrate 110B and masked to achieve specific anchoring energy and direction. UV light masking of various patterns, including specific directional application may be used to form individual pixels. Pixels may be formed with different rub characteristics, depending on the tunable application.

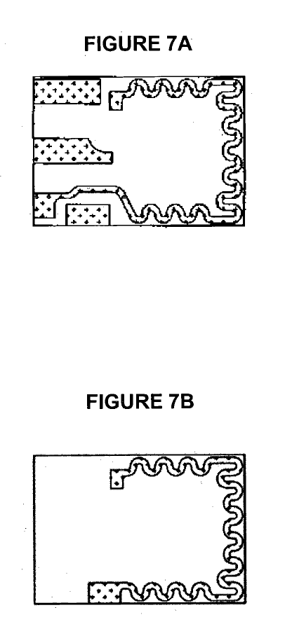

Optional step six involves creating the active thermal element, integrated heater and temperature sensor. FIGS. 7A and 7B show example masks that may be use with respect to process step 206 of FIG. 5, in which a seed adhesion layer of chrome is first deposited approximately 200 angstroms thick onto the substrates, followed by a PECVD deposition thin film platinum resistor layer approximately 2000 angstroms thick and forming the upper and lower portions of the integrated heater/temperature sensor. The upper and lower portions of the integrated device, applied to substrates 110A and 110B, may be separated by an air gap approximately 9.6 microns and interconnected by VIAS formed from a metal deposition step that will be described in succeeding step eight. Again, it need be stated that gap thickness is delineated for example purposes and will change depending on the desired application. It should be stated that, depending on the configuration, the platinum thin film resistor may be patterned in various shapes, including but not limited to arched, curved, circular, zigzag, stripped as well as the serpentine pattern of FIGS. 7A and 7B. Given the resistivity of the thin film platinum, approximately 10.6 E-8 ohm meters, the example shown yields approximately 100 ohms resistance at room temperature.

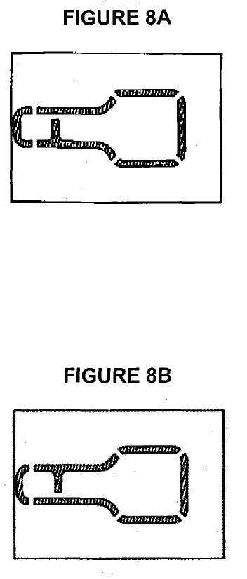

Step seven involves creating the spacer element 107. Spacer element 107 controls the gap thickness of the liquid crystal cell. While it is not necessary to equally distribute the spacer element equally on each substrate, it is preferred that one half of the desired gap thickness of the completed cell shall define the thickness of the spacer element 107 as deposited on each substrate. The combined NBTF pixel array 100 gap thickness may therefore be formed with a tolerance based on the deposition process. AL₂O₃ is the preferred material for creating the spacer element, however other materials such as silicon dioxide, aluminum oxide, silicon nitride, silicon monoxide and other materials compatible with thin film deposition processes that do not substantially compress may also be used as an alternative to the silicon dioxide provided they are compatible with the selected liquid crystal substrate material. FIGS. 8A and 8B show an example mask that may be used to perform the process step 207 of FIG. 5, where a patterned layer of 5 microns thick of silicon dioxide is deposited onto each substrate.

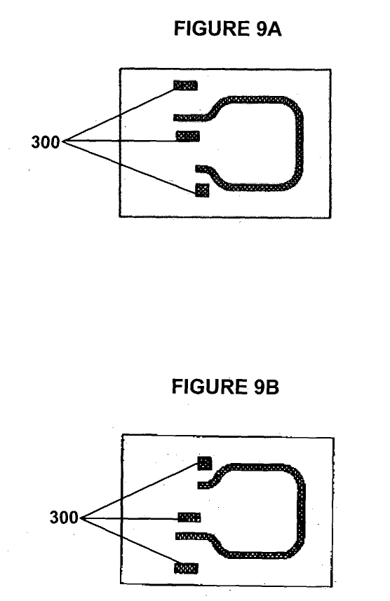

Step eight involves creating the metal gasket element 106. Metal gasket element 108 may be made from a variety of metals, including but not limited to, indium, gold, nickel, tin, chromium, platinum, tungsten, silver, bismuth, germanium and lead. However it is preferable to use a gold/tin composition because of its strength and melting temperature. FIGS. 9A and 9B show example masks that may be used to perform process step 208 of FIG. 5, where, for the continuing example purpose, a layer approximately 7 to 9 microns thick of indium may equally be deposited on each substrate. It is generally preferable that metal gasket layer of this process step is deposited thicker than the spacer element of the previous step due to seepage that occurs during the additional processing steps. Metal gasket masks, such as those shown in FIGS. 9A and 9B, may be configured to form referential VIAS 300 that enable electrical interconnection between features deposited on either substrate 110A or 110B. VIAS 300 may also be formed to simplify routing external contact pads to the temperature sensor and heating element. For example the VIAS 300 of the present example are positioned to overlap the heater/temperature sensor platinum layer defined in step six. They are also positioned to overlap the ITO layer so as to define contact pads to drive the two electrodes of the liquid crystal cell.

Step nine involves aligning and pressing wafers 110A together with 110B. It is known that visual alignment reference marks may be etched into the underlying wafer, or that a physical feature of the glass sheet such as an edge or alignment hole may be used to perform wafer alignment. However, a high yield method of accurately aligning the relative position of the two glass substrates without the need for expensive high precision alignment equipment is hereby presented, in which complimentary interlocking geometric features deposited on each substrate, mate with each other to prevent relative movement of the glass sheets during the bonding and pressing process. Such interlocking features mitigate any non uniformity in the bonding process and given that the typical gap between two glass sheets of a liquid crystal cell is less than 20 micrometers, thin film deposition or screening processes can be used to create precisely controlled and repeatable geometric features. With respect to process step 209 of FIG. 5, the substrates 110A and 110B may be brought together, aligned under pressure at room temperature to form a chemical bond metal gasket at the gap distance defined by the sandwich spacer elements formed from both substrates.

Step ten involves dicing of the wafers. Process step 210 of FIG. 5 may be performed using a dicing saw or via etching techniques.

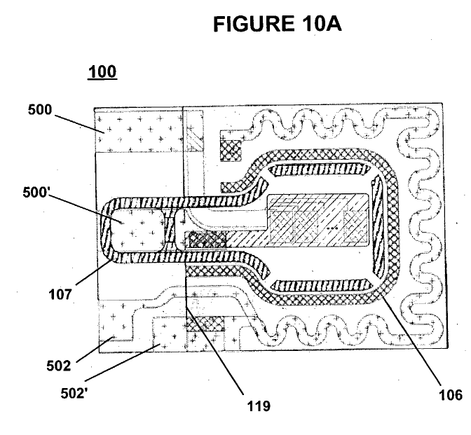

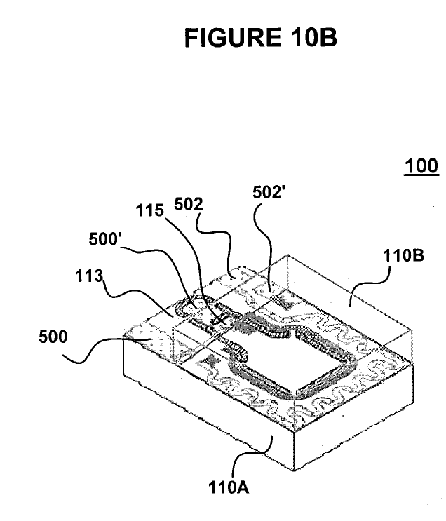

Step 11 involves removal of a portion of protective glass on the liquid crystal cell. FIG. 10A shows a top perspective of the various layers that combine through the substrates when interposed thereupon each other in a fully configured embodiment of the present invention. With respect to process 211 of FIG. 5, the substrate 110B is scored using a diamond dicing saw to cut a trench approximately 90% through the thickness of the substrate and forming the break off line 119 of FIG. 10A. A portion of the substrate 110B is broken off along the break off line 119 to define an access surface 113 of FIG. 10B that provides access to the underlying liquid crystal electrode contact pads 500 and 500′, the underlying liquid crystal heater/temperature sensor element electrical contact pads 502 and 502′, as well as to the liquid crystal fill port 115.

Step 12 involves filling the liquid crystal device with a liquid crystal molecules, process 212 of FIG. 5. This step may be performed using traditional methods of filling a liquid crystal cell, whereby the cell is placed in a vacuum, a droplet size of liquid crystal material is placed at the fill port 115, and with the release of the vacuum, equilibrium pressure forces the liquid crystal material into the fill port 115 and the fill port is plugged. Several techniques to cap the fill port, including UV curable-epoxy which may be used to close the fill port.

The present invention includes various liquid crystal configurations designed to function in a variety of specific optical systems and applications. More specifically, the tunable filter may be tailored for specific optical applications, including, but not limited to spectroscopy and optical power monitoring applications.

Thermal Management

Any non-linearity in changing the center wavelength of the filter may be algorithmically compensated using a slightly modified thermal calibration and operating processes of the present invention in which a three dimensional curve fit is used to model a parameter space including either wavelength versus voltage and temperature or wavelength versus switching time transition and temperature. This modification will be evident upon review of the thermal compensation calibration and operating loop now described:

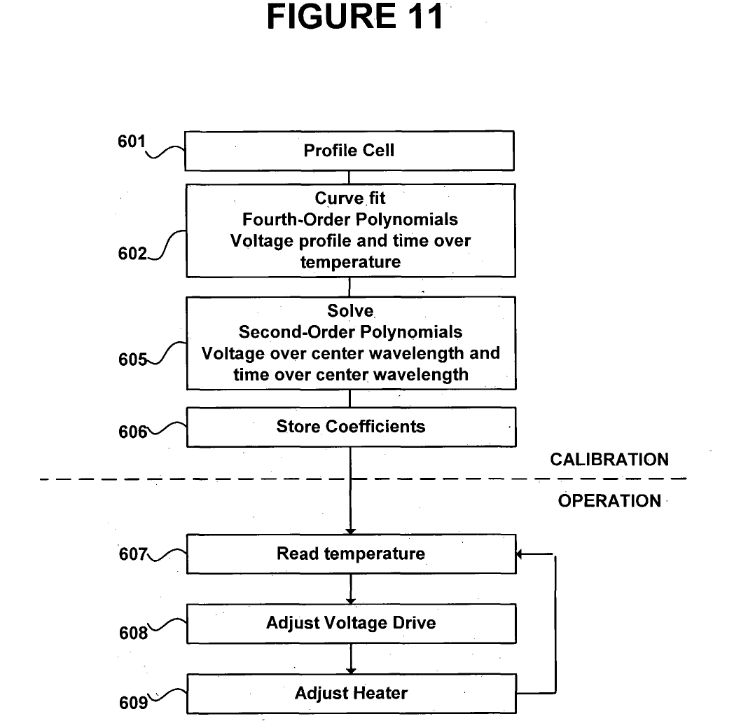

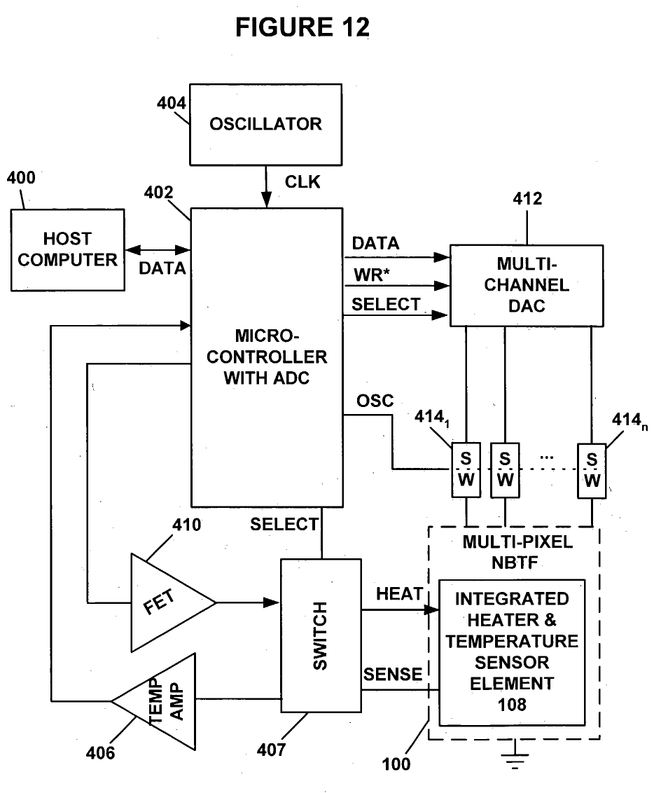

A block diagram of the control system and components directed to a liquid crystal tunable filter are included in FIGS. 11 and 12 along with the liquid crystal thermal management and voltage controller subsystems of the present invention, now described in further detail.

In one example configuration, host computer 400 may be configured to communicate with microcontroller 402 over a full duplex data interface and enabling the host computer to engage functions, send commands and retrieve data from microcontroller 402. Microcontroller may be configured to store software control routines. The software control routines may function to adjust voltage drive provided to each pixel in the liquid crystal cell in response to temperature fluctuations.

The microcontroller may utilize a time division multiplexing scheme that multiplexes temperature sensing and heating functions in the integrated sensor/heater device such that the cell may generally be kept at a constant temperature. Alternately, a calibration process characterizes the profile of the cell and generates a polynomial regression formula that provides the optimal voltage drive output for given temperature and cell state inputs. The microcontroller 402 stores the state of the liquid crystal cell, the regression formula, and reads the temperature of the liquid crystal cell to compute and assert the temperature compensated voltage drive.

FIG. 11 shows a calibration process that may be used to perform the method of the present invention in which a liquid crystal cell thermal operating characteristic profile is translated into deterministic coefficients assembled into a stored regression formula used to adjust the voltage drive to the cell in response to temperature and cell state. Note that, if the pixel center wavelength is staggered by means of patterning the filters with unique grating periods, all of the pixels, sectors, and stages can be electrically tied and controlled together. However, if the grating period is uniform and the ITO is pixilated, the control algorithms described below apply to each individual pixel but the equations will differ by a per pixel offset.

The first step to determine the coefficient values in the cell's temperature and voltage compensation profile, is to profile the liquid crystal cell drive characteristics across a range of temperatures. The profile process step 601 may examine a light source passing through the cell and its center wavelength at a given voltage and temperature combination. An operational liquid crystal cell is placed in a thermal chamber programmed to change operating temperature across the desired temperature range at a given interval. At every temperature change interval, a range of voltages are provided to the liquid crystal cell while a performance characteristic, such as center wavelength, is measured. Voltage is scanned until to achieve maximum spectra range, at which point the voltage, center wavelength and temperature levels are stored as a grid reference in a cell profile definition table. The performance of the liquid crystal cell is recorded at grid point center wavelength and temperature levels, resulting in a multi dimensional table whereby any temperature and voltage input provides an center wavelength level output. This table may be represented as a three dimensional surface.

In addition, the center wavelength versus time profile is measured at each temperature as the voltage is scanned from maximum to minimum, and visa versa.

The second step requires processing the lookup table to smooth the voltage profile over temperature and the time profile over temperature at the given center wavelength levels as recorded in the previous step. A statistical program capable of performing regression analysis, such as Mathematica® may be used to perform this process step 602. The regression software is provided with the look up table generated in step one, and performs a fourth order regression curve fitting process that generates for each center wavelength level, the appropriate coefficients a,b,c,d, and e representing a voltage versus temperature or time versus temperature profile of the cell at each center wavelength level, represented by the following formula,
v=a+bT+cT²+dT³+eT⁴
v₁=a₁+b₁T+c₁T²+d₁T³+e₁T⁴
v₂−a₂+b₂T+c₂T²+d₂T³+e₂T⁴
vₙ=aₙ+bₙT+cₙT²+dₙT³+eₙT⁴
where V=voltage, T=liquid crystal cell temperature, a,b,c,d,e curve fit coefficients, and n attenuation level.

The same fit of voltage verses temperature is now repeated with response time versus temperature. Response time is initiated by voltage application or removal. This is performed using the same polynomials as above but the voltage variable will be replaced with time.

Given that smooth curves result from the prior step that define the optimal voltage drive level and time from switching for a given temperature at the recorded grid center wavelength level, step three results in smooth curve regressions fit across orthogonal axis of the three dimensional surface, whereby the smooth curves are fit over the coarse center wavelength grid recorded in step 1. In this third process step 603, the five coefficients of the previous step are each solved by a second order regression. Specifically, Mathematica® or any suitable program is used to solve for the three coefficients that fit the profile of each of the five coefficients a,b,c,d and e across all of the orders of the regression vₙ=aₙ+bₙT+cₙT²+dₙT³+eₙT⁴ (as previously stated, substitute voltage with time for the alternate calibration method). So, a smooth surface profile defines the optimum voltage compensation level (or the predicted time from voltage application/removal) given an input center wavelength state and temperature by the following formula:
v=a+bT+cT²+dT³+eT⁴, where,
a=(X+Yθ+Zθ²
b=(X₁+Y₁θ+Z₁θ²)
c=(X₂+Y₂θ+Z₂θ²)
d=(X₃+Y₃θ+Z₃θ²)
e=(X₄+Y₄θ+Z₄θ²)
   Theta liquid crystal center wavelength
X,Y,Z=solution to zero order coefficient
X₁,Y₁,Z₁=solutions to first order coefficient
X₂,Y₂,Z₂=solutions to second order coefficient
X₃,Y₃,Z₃=solutions to third order coefficient
X₄,Y₄,Z₄=solutions to fourth order coefficient

The fifteen coefficient solutions (Xn,Yn,Zn) where n=0 to 4, may be generated by Mathematica, using the Fit (data, {1,x,xˆ2, . . . ,xˆn},x) function or other suitable software packages capable of performing curve fitting regression.

Step four is the final step in the calibration process of FIG. 11, process 606, and results in storing the coefficients in the liquid crystal control system which is now described.

The coefficients that profile the liquid crystal characteristics may be stored in microcontroller 402 memory (FIG. 12) by flashing the memory of the microcontroller with the appropriate 15 coefficient values.

Depending on response and accuracy requirements for the application, the thermal compensation system of the present invention could operate by reading the temperature of the liquid crystal cell and adjusting the voltage drive of the cell based on the cell state. The cell state may typically be at any center wavelength in the spectral range. The cell state may be stored in the microcontroller 402 and also be configured via the host computer 400.

Alternately, when a full spectral measurement is needed, voltage can be applied directly from minimum to maximum and the temperature calibration is used to correlate center wavelength versus time.

Microcontroller may be a PIC microchip having an internal analog digital converter and operating with a 10 Mhz crystal oscillator 404 clock. The microcontroller may be programmed to cycle through all pixels in the cell to controllably apply voltage to each pixel. The microcontroller may be connected to a multi-channel digital analog converter (DAC) configured to provide an output voltage level in response to a configuration pulse stream from the microcontroller over a serial interface. The output of the DAC connects to the input of an analog switch array having switching element 414′ associated with each pixel in the cell. Each element in the switch array 414 preferably shares a 1.2 khz clock provided by an output port pin of the microcontroller.

Other drive frequencies may be used to actuate the liquid crystal material. In addition, A frequency modulated drive may be incorporated into the platform to replace the amplitude modulated voltage drive. Such FM drive may also be optimized using the same methodology as described later in the thermal compensation calibration and operation loops.

With respect to the continuing example and for any given pixel, DATA is passed to the DAC along with a SELECT pulse train encoding the appropriate voltage amplitude at the Nth output channel. A WR command sent to the DAC causes the DAC output to be received at the input of the Nth analog switch 414ⁿ, triggering the application of an AM transmission over a 1.2 khz carrier to be applied to the appropriate liquid crystal cell electrode 500^{N}. As the microcontroller cycles through each iteration of the process steps described above, N is incremented and the voltage is applied the next pixel in the system.

A temperature sensor reading may be provided by the internal integrated heater/temperature sensor from an external device. One of the heater/temperature sensor electrodes 502 or 502′ of the NBTF pixel array 100 may be grounded while the other may connect to switch 407. Switch 407 may selectively engage the integrated heater/temperature sensor element 108 in a sense or heat mode. More specifically, switch 407 may be configured ON to connect the ungrounded heater/temperature electrode through instrumentation amplifier 406 to an ADC coupled to the microcontroller which reads the temperature on the liquid crystal cell, or it may be configured OFF so that power amplifier FET 410, which may be controlled by a pulse train from microcontroller 402 and applies a voltage potential to operate the device 108 as a heater.

In a temperature sense feedback closed loop operation, which shall hereby be referred to as the loop embraced by process steps 607 through 609 of FIG. 11, the microcontroller reads the temperature of the liquid crystal cell and calculates the voltage drive based on the sensed temperature, T, and the current state of each pixel, Theta. The fifteen coefficients are plugged back into the fourth order regression formula to establish a smooth surface profile delineating an optimal voltage to supply to the pixel for a given temperature and pixel center wavelength:
v=(X+Yθ+Zθ²)+(X₁+Y₁θ+Z₁θ²)T+(X₂+Y₂θ+Z₂θ²)T²+(X₃+Y₃θ+Z₃θ²)T³+(X₄+Y₄θ+Z₄θ²)T⁴

The new voltage value V is stored in the microcontroller for transmission to the DAC 412 during the next voltage application cycle.

The time calibration method is applicable to all of the above steps where, again, time is the variable replacing voltage, and this method applies when the entire spectral range is scanned.

The liquid crystal cell may also be maintained about a reference temperature. Process step 609 with respect to FIG. 11 involves the application of heat to maintain the temperature of the liquid crystal cell about a reference temperature. The reference temperature may be above the ambient room temperature or above the temperature of any carrier device that may be coupled to the liquid crystal cell. The selection of a reference temperature above the ambient temperature will result in the tendency of the liquid crystal cell to cool to meet the ambient temperature after the application of a heat burst. A counter thermal bias is therefore generated to support temperature stability about the reference temperature.

Microcontroller memory may store the reference temperature, the value of the current temperature, historical temperatures, and, historical levels of heat applied to the liquid crystal cell. The value of the sensed temperature T at every instance may be compared against the reference temperature to determine the amount of heat to apply to the liquid crystal cell. An 8 bit analog digital converter will provide approximately ⅓ of a degree of temperature sensing resolution over the desired temperature range, so the example system may provide for temperature stability about a reference temperature to within ⅓ degree Celsius. At every instance of process step 609, a threshold detector routine stored in microcontroller ROM may trigger a control function if the sensed temperature of the liquid crystal cell falls below the desired operating reference temperature. The control function may determine how much heat to apply to the liquid crystal cell. The control function may utilize error minimizing routines that track the change in temperature across multiple instances of process step 609. The error correcting routines may store the previous temperature reading T0 along with the previous amount of heat applied to the liquid crystal cell H0. The temperature reading and every succeeding temperature reading T1 may be compared against T0 to determine the amount of temperature change resulting from the previous heating of the liquid crystal cell. Heat may be applied to the liquid crystal cell by way of the FET power driver as described above. The heater may be triggered at a fixed or variable duty cycle and controlled using frequency or amplitude modulation.

Although the present invention has been fully described by way of description and accompanying drawings, it is to be noted that various changes and modifications will be apparent to those skilled in the art. For example, although multiple stages are shown in the examples provided, a one stage filter is within the scope of the present invention. Any number of pixels, sectors, and stages may be configured into a system. Sectors and stages may be omitted in the simplest form of the present invention. The NBTF may be individually controlled or controlled by way of a common electrode. A reflective sidewall surface on one stage may be shared by a predecessor or successor stage that does not contain a reflective surface in the shared area. Various patterns may be used to form the spacer element, metal gasket and integrated heater/temperature sensor elements of the multi-pixel cell platform. Use of external temperature sensors and heaters in part or whole may be applied using the temperature compensation methods and regression of the present invention. The metal gasket may be modulated to provide heating function in addition to its function as a moisture barrier support membrane. Epoxy gaskets may be used in combination with metal gasket elements in part or whole, and the metal gasket elements may comprise a single solder cap. Anchoring and aligning the liquid crystal material in a cell may also be performed using photo alignment material, Staralign by Vantio of Switzerland or other known alignment methods, including laser etching. The process steps for the closed loop temperature feedback may also be rearranged such that the heating process is performed prior to applying the voltage drive. The heater apparatus or the temperature compensation method may be configured in a tunable filter. Similarly, the heater apparatus and the temperature compensation method may both be configured in a tunable filter. The order of fitting voltage with each dimension of the three dimensional surface is reversible and other three dimensional surface fitting algorithms may be used, including but not limited to those that describe a surface with one dimension fitting a fourth degree polynomial and the other dimension fitting a second degree polynomial. Amplitude or frequency modulation may be used to tune the liquid crystal tunable filter. It is well within the scope of the present invention to make modifications to the electrode masks to produce any size array of NBTF pixels. Finally, it is well within the scope of the present invention to change the electrode masks accordingly to modify the shape of each pixel.

Therefore, it is to be noted that various changes and modifications from those abstractions defined herein, unless otherwise stated or departing from the scope of the present invention, should be construed as being included therein and captured hereunder with respect to the claims.

1. A tunable optical filter comprising a narrowband tunable filter array deposited on an inside surface of a first and second substrate, and, a reflective coating deposited on an outer surface of each substrate.

2. The tunable optical filter of claim 1, further comprising a patterned hole in at least one reflective surface to allow a light signal to pass.

3. The tunable optical filter of claim 1, wherein the narrowband tunable filter is a liquid crystal device.

4. The tunable optical filter of claim 1, further including a quarter wave reflective rotator on an outer surface of at least one of the substrates.

5. The tunable optical filter of claim 1, wherein the narrowband tunable filters are bi-directional devices that pass a transmission band and reflect a passband.

6. The tunable optical filter of claim 1, wherein each narrowband tunable filter further is individually controlled by an application of voltage to an electrode layer associated therewith.

7. The tunable optical filter of claim 1, wherein the narrowband tunable filters are configured with slightly different center wavelength resonant frequencies.

8. The tunable optical filter of claim 2, wherein at least one hole is positioned at the input of the device.

9. The tunable optical filter of claim 2, wherein at least one hole is positioned at the output of the device.

10. The tunable optical filter of claim 7, wherein the narrowband tunable filter array further including a common electrode layer.

11. The tunable optical filter of claim 10 wherein the device is tuned by an application of voltage to the common electrode layer.

12. A tunable optical filter comprising N stages, each stage comprising a narrowband tunable filter array deposited on an inside surface of substantially parallel first and second substrate each of which first and second substrates having a reflective coating deposited on an outer surface.

13. The tunable optical filter of claim 12, wherein the pixels are aligned in a single row or column, along the length of the substrate.

14. The tunable optical filter of claim 12, wherein the pixels are aligned in a single row and column along the length and width of the substrate.

15. The tunable optical filter of claim 12, wherein an optical signal input to the filter will be split into a transmission band and a passband signal.

16. The tunable optical filter of claim 13, wherein each stage further includes holes which allows a group passband signal to enter and exit.

17. The tunable optical filter of claim 13, wherein at least one stage has associated therewith array members of the narrowband tunable filter grouped into sectors.

18. The tunable optical filter of claim 17, wherein each sector associated with said stage produces a group passband output.

19. The tunable optical filter of claim 18, wherein at least one of said sectors produces a group transmission output which couples to an input of another of said sectors.

20. The tunable optical filter of claim 19, further including a MUX for combining group passband signals.

21. The tunable optical filter of claim 20, wherein the MUX includes an integrated photodetector tap.

22. A tunable optical filter comprising,
a narrowband tunable filter array deposited on an inside surface of a first and second substrate, and a reflective coating deposited on an outer surface of each substrate, and,
a temperature compensation means for controlling the tunable optical filter.
